(19) United States
(12) Patent Application Publication
(10) Pub. No.: US 2025/0090413 A1
(43) Pub. Date: Mar. 20, 2025

(54) BUILT-IN INFLATION MECHANISM FOR SEX TOY AND INFLATING METHOD THEREOF

(71) Applicant: NACHUAN CHEN, SHENZHEN (CN)

(72) Inventor: NACHUAN CHEN, SHENZHEN (CN)

(21) Appl. No.: 18/766,754

(22) Filed: Jul. 9, 2024

(30) Foreign Application Priority Data
Sep. 18, 2023 (CN) 202311206213.5
Sep. 18, 2023 (CN) 202322538202.9

(51) Int. Cl. A61H 19/00

(52) U.S. Cl. CPC A61H 19/44; A61H 2201/0103; A61H 2201/1253

(57) ABSTRACT

A built-in inflation mechanism for a sex toy and an inflating method thereof are provided. The built-in inflation mechanism for the sex toy includes a fixing sleeve, a piston sleeve, and a three-way guide pipe disposed in a main body. An air cavity is defined in a top end of the main body, an upper end of the piston sleeve is disposed at a bottom portion of the air cavity, and the upper end of the piston sleeve is communicated with the bottom portion of the air cavity through at least one air injection hole. A one-way air injection valve plate is disposed on the upper end of the piston sleeve and covers the at least one air injection hole. A spring is disposed between the piston sleeve and the fixing sleeve, and the spring is configured to drive the piston sleeve to elastically move upward.

### TECHNICAL FIELD

The present disclosure relates to inflation mechanisms for sex toys, and in particular to a built-in inflation mechanism for a sex toy and an inflating method thereof.

### BACKGROUND

Generally, current sex toys made of silica gel materials expand or contract using an inflation manner. Specifically, Chinese patent application Pub. No. CN107468497A discloses a sex toy proving a natural human body sensation, including following features.

The sex toy providing the natural human body sensation is provided, in which a cylinder and a hanging sphere are provided to imitate a male penis and a testicle; when continuously squeezing an air inflation bag, an air storage cavity is inflated and expanded to form an effective support for the cylinder, so that the cylinder is strong and firmly erects and an erection function of the male penis is effectively imitated; when pressing an air valve to deflate the air storage cavity, the cylinder is restored to a soft body shape, so that the cylinder is capable of being changed from a soft body state to an erection state or changed from the erection state to the soft body state when being in use; meanwhile, the cylinder is deigned to be of a three-layer structure, since a hardness of an intermediate layer is Shore A 0, outer layers of the cylinder may wriggle or slide with respect to the intermediate layer, thereby imitating foreskin and corpora cavernosa of the male penis. In this way, the sex toy provides the natural human body sensation and a contact effect being closer to real sex.

However, in an inflation mechanism of the sex toy disclosed in the Chinese patent application Pub. No. CN107468497A, the air inflation bag needs to be continuously squeezed to inflate and expand the air storage cavity first, an expansion degree of the sex toy keeps unchanged before working or after working, which cannot imitate a real gradual erection effect of the male penis, so that application requirements cannot be fully met.

### SUMMARY

Aiming at deficiency in the prior art, the present disclosure provides a built-in inflation mechanism for a sex toy and an inflating method thereof, which are capable of being gradually inflated during use, so as to gradually expand the sex toy.

In order to solve above technical problems, the present disclosure provides following technical solutions.

The present disclosure provides the built-in inflation mechanism for the sex toy, including a main body, a fixing sleeve, a piston sleeve, and a three-way guide pipe. The fixing sleeve, the piston sleeve, and the three-way guide pipe are disposed in the main body. An air cavity is defined in a top end of the main body, an upper end of the piston sleeve is disposed at a bottom portion of the air cavity, and the upper end of the piston sleeve is communicated with the bottom portion of the air cavity through at least one air injection hole. A one-way air injection valve plate is disposed on the upper end of the piston sleeve and covers the at least one air injection hole. A lower end of the piston sleeve is sleeved on an upper end of the fixing sleeve, and the lower end of the piston sleeve is communicated with the upper end of the fixing sleeve. A spring is disposed between the piston sleeve and the fixing sleeve, and the spring is configured to drive the piston sleeve to elastically move upward. A first one-way valve and a second one-way valve are disposed at a bottom portion of the fixing sleeve, an upper end of the first one-way valve is communicated with the fixing sleeve, an upper end of the second one-way valve is communicated with the air cavity through an exhaust pipe, a lower end of the first one-way valve is communicated with a first port of the three-way guide pipe, and a lower end of the second one-way valve is communicated with a second port of the three-way guide pipe. A third port of the three-way guide pipe is configured to be communicated with external air. A switch mechanism is disposed at a side portion of the main body, and the switch mechanism is configured to drive the second one-way valve to open. When the top end of the main body is subjected to pressure, the fixing sleeve moves downward with respect to the piston sleeve, and air in the fixing sleeve and the piston sleeve passes through the at least one air injection hole and the one-way injection valve plate and enters the air cavity; when the spring drives the piston sleeve to elastically move upward, the air is sucked into the fixing sleeve and the piston sleeve through the first one-way valve and the three-way guide pipe; and when the switch mechanism is triggered, the switch mechanism drives the second one-way valve to open, air pressure in the air cavity is released to the external air after passing through the exhaust pipe, the second one-way valve, and the three-way guide pipe.

Furthermore, a recessed portion is formed on the upper end of the piston sleeve, the one-way air injection valve plate is disposed in the recessed portion. A through hole is defined on a middle of a bottom portion of the recessed portion, a plurality of air injection holes are provided, and the plurality of the air injection holes are disposed around the through hole. The exhaust pipe passes through the through hole, the one-way air injection valve plate is disposed on a top end of the exhaust pipe and is integrated with the top end of the exhaust pipe.

Furthermore, the spring is disposed in the piston sleeve, and the spring is clamped between an outer upper end wall of the fixing sleeve and an inner top wall of the piston sleeve.

Furthermore, a clamping ring is sleeved on the lower end of the piston sleeve and is fixedly connected to the lower end of the piston sleeve. At least one limiting block is disposed on an inner side of the clamping ring, at least one vertical sliding groove is defined on an outer side wall of the fixing sleeve, the at least one limiting block is disposed in the at least one vertical sliding groove and is slidably matched with the at least one vertical sliding groove. An inverted L-shaped locking groove is defined at an upper end of the at least one vertical sliding groove, and the at least one limiting block is capable of sliding into the inverted L-shaped locking groove.

Furthermore, a first one-way valve base and a second one-way valve base are disposed at the bottom portion of the fixing sleeve, the first one-way valve is disposed in the first one-way valve base, and the second one-way valve is disposed in the second one-way valve base.

Furthermore, a first duck-billed valve core is disposed in the first one-way valve, and a second duck-billed valve core is disposed in the second one-way valve.

Furthermore, the main body includes a bottom base, a lower end of the fixing sleeve is fixedly connected to the bottom base, and the switch mechanism is disposed in the bottom base.

Furthermore, the switch mechanism includes an elastic component and a button, the button is disposed on the elastic component, a button cap of the button passes through the main body and extends outward, one end of the button away from the button cap abuts against a side portion of the second one-way valve base.

Furthermore, a guide pipe is disposed in the base, a first end of the guide pipe is communicated with the third port of the three-way guide pipe, and a second end of the guide pipe passes through the main body.

The present disclosure further provides an inflating method, applied to the sex toy and implemented by the built-in inflation mechanism for the sex toy as foregoing. The inflating method includes applying the pressure on the top end of the main body, moving the fixing sleeve downward with respect to the piston sleeve, passing the air in the fixing sleeve and the piston sleeve through the at least one air injection hole and the one-way injection valve plate to enter into the air cavity; driving the piston sleeve to elastically move upward by the spring, and sucking the air into the fixing sleeve and the piston sleeve through the first one-way valve and the three-way guide pipe; and triggering the switch mechanism to drive the second one-way valve to open, passing the air pressure in the air cavity through the exhaust pipe, the second one-way valve, and the three-way guide pipe to be released to the external air.

The present disclosure provides the built-in inflation mechanism for the sex toy, when using the sex toy, the top end of the main body is repeatedly subjected to a push-pull force, and when the main body is subjected to the pressure, the fixing sleeve is pressed downward with respect to the piston sleeve, the air in the fixing sleeve and the piston sleeve pushes the one-way air injection valve plate away, the air passes through the at least air injection hole and enters the air cavity, and when the top end of the main body is not subjected to the pressure, the spring drives the piston sleeve to move upward and reset, at this time, the external air passes through the first one-way valve and enters inner spaces of the fixing sleeve and the piston sleeve, when the top end of the main body is repressed, the air cavity achieves air supplementation, and after repeatedly implementing such actions, the air cavity is gradually expanded, so that the main body is changed from a soft body state to an erection state. After use of the sex toy, the switch mechanism is triggered to drive the second one-way valve to open, the air pressure in the air cavity is released to the external air after passing through the exhaust pipe, the second one-way valve, and the three-way guide pipe, so that the main body is changed from the erection state to the soft body state. Compared with the prior art, the built-in inflation mechanism for the sex toy of the present disclosure is capable of being gradually inflated during use, so as to gradually expand the sex toy, in this way, user experience of the sex toy is closer to reality, thereby better meeting application requirements of users.

### BRIEF DESCRIPTION OF DRAWINGS

FIG. 1 is a three-dimensional structural schematic diagram of a main body.

FIG. 2 is an exploded structural schematic diagram of an interior of the main body.

FIG. 3 is a cross-sectional schematic diagram of a built-in inflation mechanism for a sex toy.

FIG. 4 is an enlarged schematic diagram of portion A shown in FIG. 3.

FIG. 5 is a structural schematic diagram of a piston sleeve and an exhaust pipe.

FIG. 6 is a structural schematic diagram of a switch mechanism and a bottom base.

### DETAILED DESCRIPTION OF EMBODIMENTS

The present disclosure is described in more detail below with reference to accompanying drawings and embodiments.

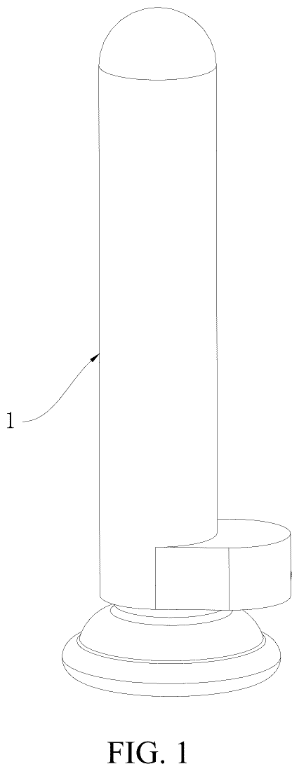

The present disclosure provides a built-in inflation mechanism for a sex toy, as shown in FIGS. 1-6, including a main body 1, a fixing sleeve 2, a piston sleeve 3, and a three-way guide pipe 4. The fixing sleeve 2, the piston sleeve 3, and the three-way guide pipe 4 are disposed in the main body 1. An air cavity 10 is defined in a top end of the main body 1, an upper end of the piston sleeve 3 is disposed at a bottom portion of the air cavity 10, and the upper end of the piston sleeve 3 is communicated with the bottom portion of the air cavity 10 through at least one air injection hole 30. A one-way air injection valve plate 60 is disposed on the upper end of the piston sleeve 3 and covers the at least one air injection hole 30. A lower end of the piston sleeve 3 is sleeved on an upper end of the fixing sleeve 2, and the lower end of the piston sleeve 3 is communicated with the upper end of the fixing sleeve 2. A spring 5 is disposed between the piston sleeve 3 and the fixing sleeve 2, and the spring 5 is configured to drive the piston sleeve 3 to elastically move upward. A first one-way valve 20 and a second one-way valve 21 are disposed at a bottom portion of the fixing sleeve 2, an upper end of the first one-way valve 20 is communicated with the fixing sleeve 2, an upper end of the second one-way valve 21 is communicated with the air cavity 10 through an exhaust pipe 6, a lower end of the first one-way valve 20 is communicated with a first port of the three-way guide pipe 4, and a lower end of the second one-way valve 21 is communicated with a second port of the three-way guide pipe 4. A third port of the three-way guide pipe 4 is configured to be communicated with external air. A switch mechanism 7 is disposed at a side portion of the main body 1, and the switch mechanism 7 is configured to drive the second one-way valve 21 to open.

When the top end of the main body 1 is subjected to pressure, the fixing sleeve 2 moves downward with respect to the piston sleeve 3, and air in the fixing sleeve 2 and the piston sleeve 3 passes through the at least one air injection hole 30 and the one-way injection valve plate 60 and enters the air cavity 10.

When the spring 5 drives the piston sleeve 3 to elastically move upward, the air is sucked into the fixing sleeve 2 and the piston sleeve 3 through the first one-way valve 20 and the three-way guide pipe 4.

When the switch mechanism 7 is triggered, the switch mechanism 7 drives the second one-way valve 21 to open, air pressure in the air cavity 10 is released to the external air after passing through the exhaust pipe 6, the second one-way valve 21, and the three-way guide pipe 4.

In a use process of the foregoing structure, when using the sex toy, the top end of the main body 1 is repeatedly subjected to a push-pull force, and when the main body 1 is subjected to the pressure, the fixing sleeve 2 is pressed downward with respect to the piston sleeve 3, the air in the fixing sleeve 2 and the piston sleeve 3 pushes the one-way air injection valve plate 60 away, the air passes through the at least air injection hole 30 and enters the air cavity 10, and when the top end of the main body 1 is not subjected to the pressure, the spring 5 drives the piston sleeve 3 to move upward and reset, at this time, the external air passes through the first one-way valve 20 and enters inner spaces of the fixing sleeve 2 and the piston sleeve 3, when the top end of the main body 1 is repressed, the air cavity 10 achieves air supplementation, and after repeatedly implementing such actions, the air cavity 10 is gradually expanded, so that the main body 1 is changed from a soft body state to an erection state. After use of the sex toy, the switch mechanism 7 is triggered to drive the second one-way valve 21 to open, the air pressure in the air cavity 10 is released to the external air after passing through the exhaust pipe 6, the second one-way valve 21, and the three-way guide pipe 4, so that the main body 1 is changed from the erection state to the soft body state. Compared with the prior art, the built-in inflation mechanism for the sex toy of the present disclosure is capable of being gradually inflated during use, so as to gradually expand the sex toy, in this way, user experience of the sex toy is closer to reality, thereby better meeting application requirements of users.

It should be noted that a shape of the main body 1 shown in FIG. 1 is merely an application example, and in an actual design and manufacturing process, the shape of the main body 1 is not limited thereto, and may also be other shapes, so that the present disclosure does not limit a specific shape of the main body 1, that is, no matter what shape the main body 1 is designed to be, how the main body 1 is used, etc., as long as an implementation principle is the same as or equivalent to that of the present disclosure, such main body for a sex toy should all fall within a protection scope of the present disclosure.

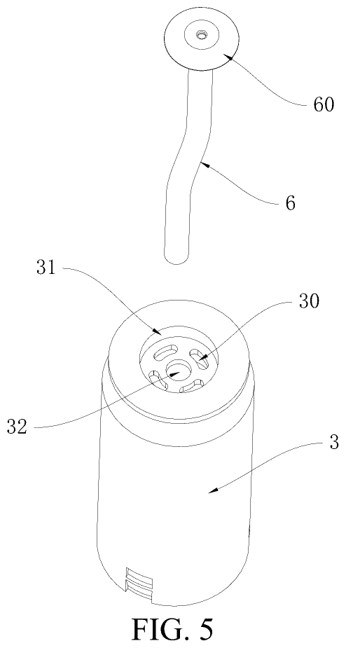

In order to better match with the one-way air injection valve plate 60, please refer to FIG. 5, a recessed portion 31 is formed on the upper end of the piston sleeve 33, the one-way air injection valve plate 60 is disposed in the recessed portion 31. A through hole 32 is defined on a middle of a bottom portion of the recessed portion 31, a plurality of air injection holes 30 are provided, and the plurality of the air injection holes 30 are disposed around the through hole 32. The exhaust pipe 6 passes through the through hole 32, the one-way air injection valve plate 60 is disposed on a top end of the exhaust pipe 6 and is integrated with the top end of the exhaust pipe 6. Specifically, the one-way air injection valve plate 60 and the exhaust pipe 6 are integrally formed, so that an umbrella-shaped component is obtained, which is convenient for mounting the one-way air injection plate 60 and is further convenient for arranging the exhaust pipe 6.

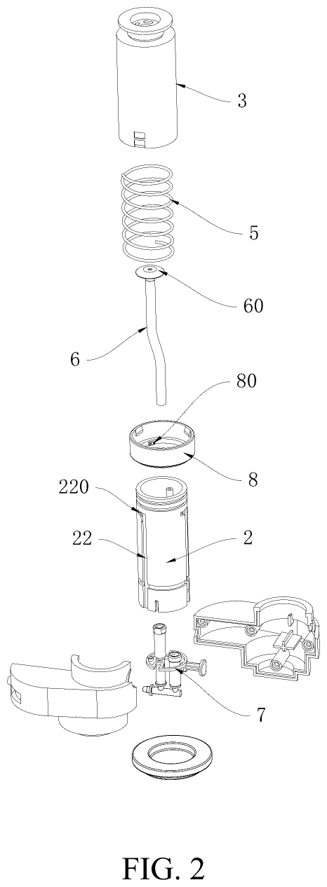

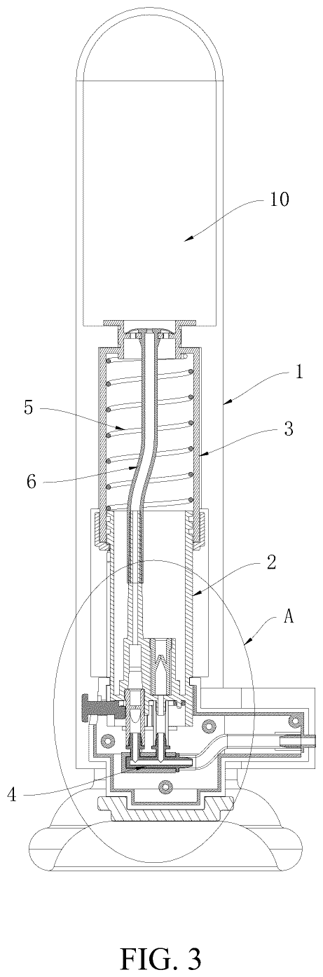

As shown in FIGS. 2-3, in the embodiment, the spring 5 is disposed in the piston sleeve 3, and the spring 5 is clamped between an outer upper end wall of the fixing sleeve 2 and an inner top wall of the piston sleeve 3.

In an optional embodiment, a clamping ring 8 is sleeved on the lower end of the piston sleeve 3 and is fixedly connected to the lower end of the piston sleeve 3. At least one limiting block 80 is disposed on an inner side of the clamping ring 8, at least one vertical sliding groove 22 is defined on an outer side wall of the fixing sleeve 2, the at least one limiting block 80 is disposed in the at least one vertical sliding groove 22 and is slidably matched with the at least one vertical sliding groove 22. An inverted L-shaped locking groove 220 is defined at an upper end of the at least one vertical sliding groove 22, and the at least one limiting block 80 is capable of sliding into the inverted L-shaped locking groove 220.

Specifically, a plurality of limiting blocks 80 are disposed on the inner side of the clamping ring 80, a plurality of vertical sliding grooves 22 are defined on the outer side wall of the fixing sleeve, the plurality of the limiting blocks 80 are in one-to-one correspondence with the plurality of the vertical sliding grooves 22 and respectively matched with each other, thereby ensuring that the piston sleeve smoothly is capable of moving in a vertical direction. On this basis, after the piston sleeve 3 is reset, slightly applying a torsion enables each of the plurality of the limiting blocks 80 to slide into a corresponding inverted L-shaped locking groove 220, at this time, the piston sleeve is limited with respect to the fixing sleeve 2, so that the sex toy keeps in the erection state.

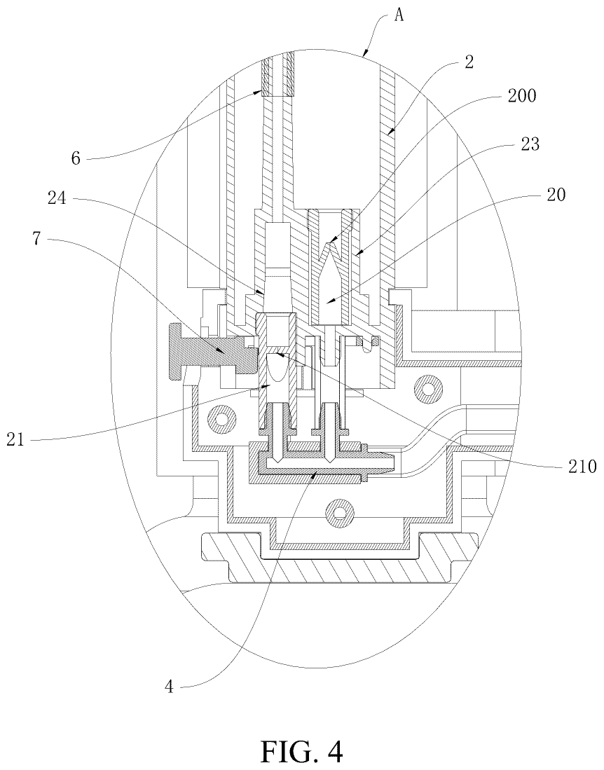

In order to facilitate mounting and fixing of the first one-way valve 20 and the second one-way valve 21, in the embodiment, as shown in FIGS. 3-4, a first one-way valve base 23 and a second one-way valve base 24 are disposed at the bottom portion of the fixing sleeve 2, the first one-way valve 20 is disposed in the first one-way valve base 23, and the second one-way valve 21 is disposed in the second one-way valve base 24.

In an optional embodiment, the first one-way valve 20 and the second one-way valve 21 are duck-billed one-way valves, please refer to FIG. 4, in the embodiment, a first duck-billed valve core 200 is disposed in the first one-way valve 20, and a second duck-billed valve core 210 is disposed in the second one-way valve 21.

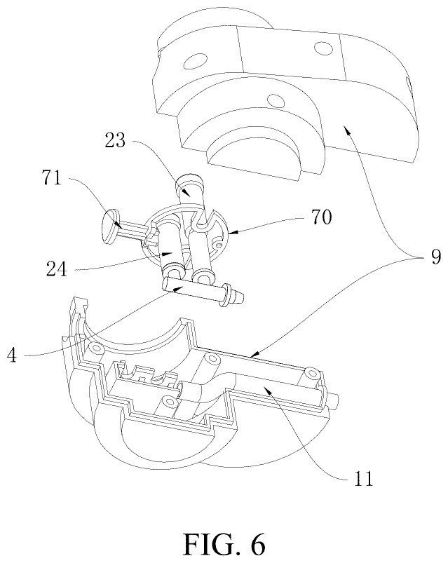

As shown in FIGS. 2 and 6, in the embodiment, the main body 1 includes a bottom base 9, a lower end of the fixing sleeve 2 is fixedly connected to the bottom base 9, and the switch mechanism 7 is disposed in the bottom base 9.

Further, the switch mechanism 7 includes an elastic component 70 and a button 71, the button 71 is disposed on the elastic component 70, a button cap of the button 71 passes through the main body 1 and extends outward, one end of the button 71 away from the button cap abuts against a side portion of the second one-way valve base 24.

Specifically, the button 71 and the elastic component 70 are integrally formed, the elastic component 70 is an annular elastic component, and when the button 71 is pressed, the one end of the button 71 away from the button cap abuts against the side portion of the second one-way valve base 24, so that the second duck-billed valve core 210 is deformed and opened, and at this time, the air pressure in the air cavity 10 is released to the external air through the exhaust pipe 6, the second one-way valve 21, and the three-way guide pipe 4.

In order to facilitate of entering of the air and releasing of the air pressure, in the embodiment, a guide pipe 11 is disposed in the base 9, a first end of the guide pipe 11 is communicated with the third port of the three-way guide pipe 4, and a second end of the guide pipe 11 passes through the main body 1.

As shown in FIGS. 1-6, the present disclosure further provides an inflating method, applied to the sex toy and implemented by the built-in inflation mechanism for the sex toy as foregoing. The inflating method is as follows.

Applying the pressure on the top end of the main body 1, moving the fixing sleeve 2 downward with respect to the piston sleeve 3, passing the air in the fixing sleeve 2 and the piston sleeve 3 through the at least one air injection hole 30 and the one-way injection valve plate 60 to enter into the air cavity 10.

Driving the piston sleeve 3 to elastically move upward by the spring 5, and sucking the air into the fixing sleeve 2 and the piston sleeve 3 through the first one-way valve 20 and the three-way guide pipe 4.

Triggering the switch mechanism 7 to drive the second one-way valve 21 to open, passing the air pressure in the air cavity 10 through the exhaust pipe 6, the second one-way valve 21, and the three-way guide pipe 4 to be released to the external air.

Compared with the prior art, the inflating method of the present disclosure is capable of gradually inflating the built-in inflation mechanism for the sex toy during use, so as to gradually expand the sex toy, in this way, the user experience of the sex toy is closer to reality, thereby better the meeting application requirements of the users.

The above are only preferred embodiments of the present disclosure and are not intended to limit the present disclosure, and modifications, equivalent replacements, or improvements made within a technical scope of the present disclosure shall fall within the protection scope of the present disclosure.

What is claimed is:

1. A built-in inflation mechanism for a sex toy, comprising:
a main body;
a fixing sleeve;
a piston sleeve; and
a three-way guide pipe;
wherein the fixing sleeve, the piston sleeve, and the three-way guide pipe are disposed in the main body; an air cavity is defined in a top end of the main body, an upper end of the piston sleeve is disposed at a bottom portion of the air cavity, and the upper end of the piston sleeve is communicated with the bottom portion of the air cavity through at least one air injection hole; an one-way air injection valve plate is disposed on the upper end of the piston sleeve and covers the at least one air injection hole; a lower end of the piston sleeve is sleeved on an upper end of the fixing sleeve, and the lower end of the piston sleeve is communicated with the upper end of the fixing sleeve; a spring is disposed between the piston sleeve and the fixing sleeve, and the spring is configured to drive the piston sleeve to elastically move upward; a first one-way valve and a second one-way valve are disposed at a bottom portion of the fixing sleeve, an upper end of the first one-way valve is communicated with the fixing sleeve, an upper end of the second one-way valve is communicated with the air cavity through an exhaust pipe, a lower end of the first one-way valve is communicated with a first port of the three-way guide pipe, and a lower end of the second one-way valve is communicated with a second port of the three-way guide pipe; a third port of the three-way guide pipe is configured to be communicated with external air; a switch mechanism is disposed at a side portion of the main body, and the switch mechanism is configured to drive the second one-way valve to open;
when the top end of the main body is subjected to pressure, the fixing sleeve moves downward with respect to the piston sleeve, and air in the fixing sleeve and the piston sleeve passes through the at least one air injection hole and the one-way injection valve plate and enters the air cavity;
when the spring drives the piston sleeve to elastically move upward, the air is sucked into the fixing sleeve and the piston sleeve through the first one-way valve and the three-way guide pipe; and
when the switch mechanism is triggered, the switch mechanism drives the second one-way valve to open, air pressure in the air cavity is released to the external air after passing through the exhaust pipe, the second one-way valve, and the three-way guide pipe.

2. The built-in inflation mechanism for the sex toy according to claim 1, wherein a recessed portion is formed on the upper end of the piston sleeve, the one-way air injection valve plate is disposed in the recessed portion; a through hole is defined on a middle of a bottom portion of the recessed portion, a plurality of air injection holes are provided, and the plurality of the air injection holes are disposed around the through hole; the exhaust pipe passes through the through hole, the one-way air injection valve plate is disposed on a top end of the exhaust pipe and is integrated with the top end of the exhaust pipe.

3. The built-in inflation mechanism for the sex toy according to claim 1, wherein the spring is disposed in the piston sleeve, and the spring is clamped between an outer upper end wall of the fixing sleeve and an inner top wall of the piston sleeve.

4. The built-in inflation mechanism for the sex toy according to claim 1, wherein a clamping ring is sleeved on the lower end of the piston sleeve and is fixedly connected to the lower end of the piston sleeve; at least one limiting block is disposed on an inner side of the clamping ring, at least one vertical sliding groove is defined on an outer side wall of the fixing sleeve, the at least one limiting block is disposed in the at least one vertical sliding groove and is slidably matched with the at least one vertical sliding groove; an inverted L-shaped locking groove is defined at an upper end of the at least one vertical sliding groove, and the at least one limiting block is capable of sliding into the inverted L-shaped locking groove.

5. The built-in inflation mechanism for the sex toy according to claim 1, wherein a first one-way valve base and a second one-way valve base are disposed at the bottom portion of the fixing sleeve, the first one-way valve is disposed in the first one-way valve base, and the second one-way valve is disposed in the second one-way valve base.

6. The built-in inflation mechanism for the sex toy according to claim 1, wherein a first duck-billed valve core is disposed in the first one-way valve, and a second duck-billed valve core is disposed in the second one-way valve.

7. The built-in inflation mechanism for the sex toy according to claim 6, wherein the main body comprises a bottom base, a lower end of the fixing sleeve is fixedly connected to the bottom base, and the switch mechanism is disposed in the bottom base.

8. The built-in inflation mechanism for the sex toy according to claim 7, wherein the switch mechanism comprises an elastic component and a button, the button is disposed on the elastic component, a button cap of the button passes through the main body and extends outward, one end of the button away from the button cap abuts against a side portion of the second one-way valve base.

9. The built-in inflation mechanism for the sex toy according to claim 7, wherein a guide pipe is disposed in the base, a first end of the guide pipe is communicated with the third port of the three-way guide pipe, and a second end of the guide pipe passes through the main body.

10. An inflating method, applied to the sex toy according to claim 1 and implemented by the built-in inflation mechanism for the sex toy, comprising:
applying the pressure on the top end of the main body, moving the fixing sleeve downward with respect to the piston sleeve, passing the air in the fixing sleeve and the piston sleeve through the at least one air injection hole and the one-way injection valve plate to enter into the air cavity;
driving the piston sleeve to elastically move upward by the spring, and sucking the air into the fixing sleeve and the piston sleeve through the first one-way valve and the three-way guide pipe; and
triggering the switch mechanism to drive the second one-way valve to open, passing the air pressure in the air cavity through the exhaust pipe, the second one-way valve, and the three-way guide pipe to be released to the external air.
